(19) United States
(12) Patent Application Publication
(10) Pub. No.: US 2008/0219114 A1
(43) Pub. Date: Sep. 11, 2008

(54) Information processing device and storage medium

(75) Inventor: Tomohiro Mukai, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/075,139

(22) Filed: Mar. 7, 2008

(30) Foreign Application Priority Data
Mar. 8, 2007 (JP) 2007-058587
Feb. 8, 2008 (JP) 2008-028727

(51) Int. Cl. G11B 5/09

(52) U.S. Cl. 369/47.15

(57) ABSTRACT

An information processing device includes a reception unit that receives a write instruction to instruct data writing into a recording medium; a plurality of drive units that perform data reading/writing from/into a recording media; a first detection unit that detects a drive unit to which a detachable recording medium is attached, from among the plurality of drive units; a second detection unit that controls the drive unit detected by the first detection unit so as to read information recorded on the detachable recording medium attached to the detected drive unit, and so as to detect a recording medium, the read information from which includes predetermined information; and a control unit that controls the drive unit to which the recording medium detected by the second detection unit is attached, so as to write data which is instructed to be written by the write instruction received by the reception unit, into the recording medium attached to the drive unit.

The entire disclosures of Japanese Patent Applications No. 2007-058587 filed on Mar. 8, 2007 and No. 2008-028727 filed on Feb. 8, 2008 are expressly incorporated by reference herein.

### BACKGROUND

1. Technical Field

The present invention relates to a technique for recording data on a recording medium.

2. Related Art

There are information display devices of a type which are commonly known as electronic books. An electronic book displays pages of a digitized book or document on a liquid crystal display. An information display device of this type is designed to read data from an attachable/detachable memory card (or recording medium) on which data of a digitized book or document is recorded. The information display device then displays pages of a book or document from the read data. In a case of using a memory card in this way, data of a book or document needs to be written into the memory card. JP-A-2006-209385 discloses a device for writing data into a memory card. A personal computer device disclosed in JP-A-2006-209385 includes plural drives which access memory cards. The personal computer device generates data expressing images of respective pages forming a document from document data expressing a document, and writes the data into a memory card by outputting the generated data to that of the plural drives in which the memory card is inserted.

In a case where a computer device including plural drives performs writing of data into a memory card, a user inserts a memory card into one of the plural drives. The computer device displays a list of available drives represented as icons, to allow the user to select one drive to use for data writing (i.e., the drive in which the memory card is inserted). Further, the computer device controls the drive selected by the user so as to write data into the memory card. However, since the drives are respectively represented as icons in the displayed list of available drives, a user may have difficulty in visually distinguishing which icon corresponds to which drive. A user who is not familiar with computer devices therefore sometimes fails to correctly select a drive in which a memory card is inserted. Consequently, the user selects a wrong drive in which no memory card is inserted, and can therefore not carry out data writing. Otherwise, such a user erroneously selects a different drive from a drive which the user wants to write data into. Then, the user may write data into a memory card other than that which the user originally wants to write the data into. In a method in which a user is allowed to select a drive to use for data writing, the user is required to select a drive each time the user is going to write data into a memory card. Making such a selection requires the user to perform complex tasks, and is not user-friendly.

### SUMMARY

The invention has been made in view of the circumstances described above and provides a technique which facilitates data writing into an attachable/detachable recording medium

According to one aspect of the invention, there is provided An information processing device including: a reception unit that receives a write instruction to instruct data writing into a recording medium; a plurality of drive units that perform data reading/writing from/into a recording media; a first detection unit that detects a drive unit to which a detachable recording medium is attached, from among the plurality of drive units; a second detection unit that controls the drive unit detected by the first detection unit so as to read information recorded on the detachable recording medium attached to the detected drive unit, and so as to detect a recording medium, the read information from which includes predetermined information; and a control unit that controls the drive unit to which the recording medium detected by the second detection unit is attached, so as to write data which is instructed to be written by the write instruction received by the reception unit, into the recording medium attached to the drive unit.

The information processing device described above writes data into a recording medium which records predetermined information.

Alternatively, the information processing device described above may be configured so that the predetermined information includes at least one of a file having a predetermined name and a folder having a predetermined name.

The information processing device configured as described above writes data into a recording medium which records information including at least one of a file having a predetermined name and a folder having a predetermined name.

Also alternatively, the information processing device described above may be configured so that the plurality of drive units are assigned successive numbers, and if the second detection unit detects a plurality of recording media which include the predetermined information, the control unit performs data writing into a recording medium which is attached to a drive unit assigned the smallest one of the successive numbers from among the detected plurality of recording media.

The information processing device configured as described above writes data into a recording medium attached to a drive unit assigned a smaller number.

Still alternatively, the information processing device described above may be configured so as to further include a storage unit that stores date/time at which each of the one or more detachable recording media are attached to the one or more drive units, wherein if the second detection unit detects a plurality of recording media which record the predetermined information, the control unit performs data writing into a recording medium which is attached to a drive unit which was attached at the most recent date/time, from among the detected plurality of recording media.

The information processing device configured as described above writes data into a recording medium attached to a drive unit which was attached at the most recent date/time.

Still alternatively, the information processing device described above may be configured so as to further include an initialization unit that controls the drive unit which has attached to it the detachable recording medium, so as to write the predetermined information into the recording medium.

The information processing device configured as described above initializes a recording medium

According to another aspect of the invention, there is provided a computer readable storage medium storing a program causing a computer device to execute a process, the process comprising: receiving a write instruction to instruct data writing into a recording medium; detecting a drive unit to which a detachable recording medium is attached, from among a plurality of drive units; controlling the detected drive unit so as to read information recorded on the detachable recording medium attached to the detected drive unit, and so as to detect a recording medium, the read information from which includes predetermined information; and controlling the drive unit to which the detachable recording medium detected to record the information including the predetermined information is attached, so as to write data which is instructed by the write instruction, into the recording medium attached to the drive unit.

### BRIEF DESCRIPTION OF THE DRAWINGS

An embodiment of the present invention will be described in detail based on the following figures, wherein:

FIG. 1 shows an entire configuration of a system according to an embodiment of the invention;

FIG. 2 is a block diagram showing a Hardware configuration of an information display device 2 according to the embodiment;

FIG. 3 is a block diagram showing a hardware configuration of the information processing device 1 according to the embodiment;

FIG. 4 is a flowchart showing a flow of processing executed by the information processing device 1;

FIG. 5 shows an example of a screen displayed on the display 108;

FIG. 6 shows another example of a screen displayed on the display 108;

FIG. 7 shows still another example of a screen displayed on the display 108; and

FIG. 8 shows still another example of a screen displayed on the display 108.

### DETAILED DESCRIPTION

### 1. Configuration

### 1-1. Entire Configuration

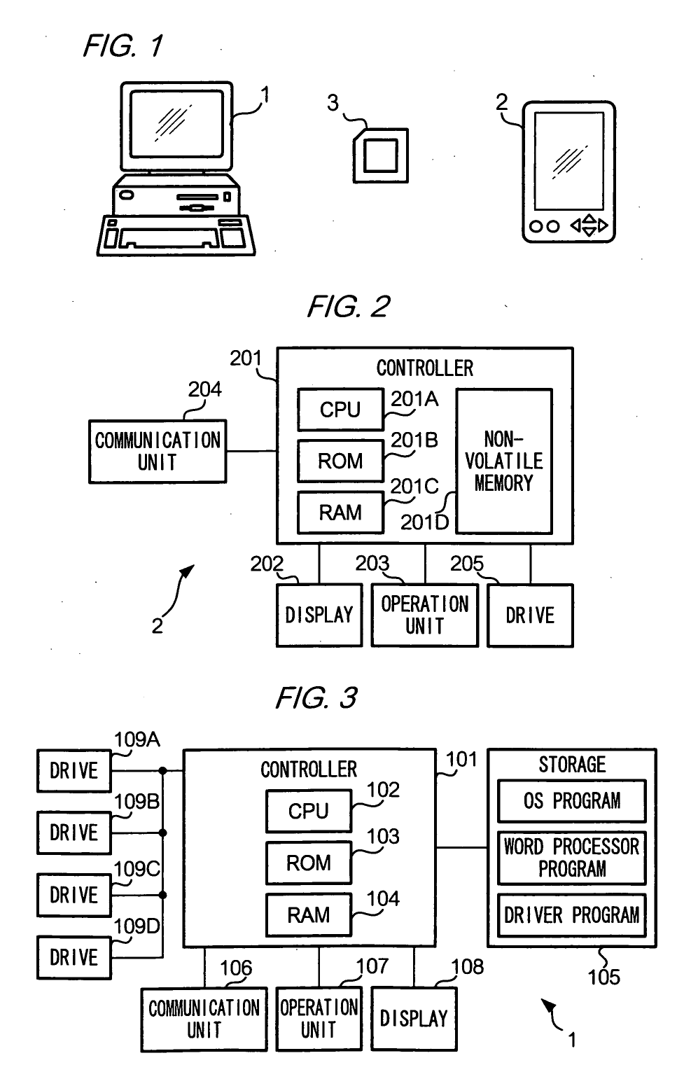

FIG. 1 shows an entire configuration of a system according to one embodiment of the invention. A memory card 3 is a storage device of a card type and has a non-volatile memory. The memory card 3 stores various data which will be described later. An information processing device 1 is a computer device which is generally known as a PC/AT compatible computer. The information processing device 1 has a drive which performs data writing into and data reading from the memory card, to write data of a digitized electronic document into the memory card 3. In the present embodiment, the information processing device 1 is not limited to a PC/AT compatible computer but may be any other type of computer device so long as the computer device has a drive and is capable of writing/reading data into/from the memory card 3. An information display device 2 is a portable device for displaying pages of digitized electronic documents. The information display device 2 also has a drive for writing/reading data into/from the memory card 3. The information display device 2 reads data of a digitized electronic document from the memory card 3 inserted in the drive for writing/reading data into/from the memory card 3, and displays the document expressed by the read data.

### 1-2. Configuration of Information Display Device 2

FIG. 2 is a block diagram showing a hardware configuration of the information display device 2. As shown in FIG. 2, the information display device 2 has a controller 201, a display 202, an operation unit 203, a communication unit 204, and a drive 205.

The display 202 is connected to the controller 201 and displays images of a document and an operation screen for operating the information display device 2 under control of the controller 201. The display 202 has a image-retaining display element which, once an image is displayed, can maintain the displayed image over a long time period without supply of electric power.

The operation unit 203 is connected to the controller 201 and has various buttons for operating the information display device 2. When a button of the operation unit 203 is operated, a signal assigned to the operated button is output to the controller 201. Signals assigned to the buttons cause various functions to be performed depending on screens which are displayed at the time the buttons are operated. For example, there is a screen showing that a cursor is located on an indication “cancel”. If a button is operated while this screen is displayed, the operation of the button is equivalent to triggering of an instruction to cancel a processing which has been executed immediately before. There is another screen showing that a cursor is located on an indication “OK”. If a button is operated while this screen is displayed, the operation of the button is equivalent to acceptance of a processing which has been executed immediately prior to operation of the button. In this manner, the controller 201 specifies instructions from users, depending on screens displayed on the display 202 and signals assigned to the buttons. In accordance with the specified instructions, the controller 201 controls respective components constituting the information display device 2.

The communication unit 204 is connected to the controller 201 and has a communication interface for communicating with the information processing device 1. The communication unit 204 has a terminal to which a communication cable is connected. Under control of the controller 201, the communication unit 204 communicates with the information processing device 1 via the communication cable connected to the terminal, whereby various data can be exchanged.

The drive 205 has an inlet port (or slot) into which the memory card 3 is inserted. The drive 205 functions to write/read data into/from the memory card 3 and is connected to the controller 201. The drive 205 reads data stored in the memory card 3, and outputs the data to the controller 201. Under control of the controller 201, the drive 205 writes various data into the memory card 3 inserted in the inlet port.

The controller 201 has a CPU (Central Processing Unit) 201A, a ROM (Read Only Memory) 201B, a RAM (Random Access Memory) 201C, and a non-volatile memory 201D. The ROM 201B stores a control program which is executed by the CPU 201A. The non-volatile memory 201D is a memory of a type which holds stored content without supply of electric power. The non-volatile memory 201D stores document image data which expresses images of a document.

When electric power is supplied from a power source (not shown in the figures), the CPU 201A in the controller 201 then executes the control program stored in the ROM 201B. As the CPU 201A executes the control program, the controller 201 controls respective components of the information display device 2. Accordingly, various functions are performed by the information display device 2 on the basis of data stored in the non-volatile memory 201D and/or memory card 3. Such various functions are, for example, a function of displaying images of documents expressed by the data, a function of displaying operation screens for operating the information display device 2 on the display 202, a function of communicating with the information processing device 1, a function of initializing the memory card 3, etc.

### 1-3. Configuration of the Information Processing Device 1

FIG. 3 is a block diagram showing a hardware configuration of the information processing device 1. As shown in FIG. 3, the information processing device 1 has a controller 101 (an example of a reception unit, a first detection unit, a second detection unit, and/or a control unit), a storage 105 (an example of storage unit), a communication unit 106, an operation unit 107, a display 108, and drives 109A to 109B (an example of plural drive units).

The communication unit 106 functions as a communication interface. The communication unit 106 is connected to the controller 101 and has a terminal to which a communication cable is connected. Under control of the controller 101, the communication unit 106 communicates with the information display device 2 via the communication cable connected to the terminal, to communicate various data. The operation unit 107 has a keyboard (not shown in the figures) and/or a mouse (not shown in the figures) for a user to input operation instructions into the information processing device 1. The display 108 includes a liquid crystal display. Under control of the controller 101, the display 108 displays various images including text, graphic images, and menu screens for operation of the information processing device 1.

The drives 109A to 109D function to read/write data into/from various recording media, and are connected to the controller 101. Specifically, the drive 109A has an inlet port where a flexible disk is inserted. Under control of the controller 101, the drive 109A reads/writes data into/from the flexible disk inserted in the inlet port. The drive 109B has an inlet port where a recording medium of an optical disk type such as a CD (Compact Disk) or a DVD (Digital Versatile Disk) is inserted. Under control of the controller 101, the drive 109B reads/writes data into/from the optical disk inserted in the inlet port. The drives 109C and 109D each have an inlet port where a memory card 3 is inserted. Under control of the controller 101, the drives 109C and 109D each read/write data into/from the memory card 3 inserted in the inlet port.

The storage 105 includes a hard disk device and stores an OS program, a word processor program, a driver program, etc. The OS program causes the information processing device 1 to function as an operating system (OS). The word processor program causes the information processing device 1 to function as a word processor, such as for creation or editing of documents. The driver program causes the information processing device 1 to perform a function of writing, into the memory card 3, data expressing images of a document created by use of the word processor program.

The controller 101 has a CPU 102, a ROM 103, and a RAM 104. The ROM 103 stores an IPL (Initial Program Loader). In the controller 101, the CPU 102 starts the IPL stored in the ROM 103 upon supply of electric power from the power source (not shown in the figures). In the present embodiment, the drive 109A is identified as “drive A”. The hard disk device in the storage 105 is identified as “drive C”. The drives 109B, 109C, and 109D are respectively identified as “drive D”, “drive E”, and “drive F”. As the OS program is executed, the controller 101 performs basic functions which a computer device usually has. Such basic functions are, for example, an input/output function including input from the operation unit 107 and screen output through the display 108, controls of the storage 105 and the drives 109A to 109D, execution of various programs stored in the storage 105, etc.

### 2. Operation

Next, operation of the present embodiment will be described below.

### 2-1. Operation when Initializing a Memory Card 3

Firstly, initialization is performed so that a memory card 3 can be used with the information processing device 1. Specifically, a user of the information display device 2 inserts a memory card 3 into the drive 205 in the information display device 2. Secondly, the user operates the operation unit 203 to instruct the information display device 2 to initialize the memory card 3. Then, the controller 201 controls the drive 205 so as to erase all folders and data stored in the memory card 3. Upon completion of erasure of the folders and data stored in the memory card 3, the controller 201 writes identification data into the memory card 3. The identification data indicates that the memory card 3 is a recording medium which can be used with the information display device 2. The identification data may be any data so long as the data can be recognized as identification data, such as a particular character string constituted of alphabet letters and numbers mixed together, or data expressing a particular file name. Initialization of the memory card 3 ends with completion of writing of the identification data. Then, the information processing device 1 and the information display device 2 identify the memory card 3, which stores the written identification data, as a memory card 3 which can be used with the information processing device 2.

### 2-2. Operation when Displaying an Image of a Document on the Information Display Device 2

Described next will be an operation performed when displaying an image of a document on the information display device 2. Firstly, a user operates the operation unit 107 of the information processing device 1 to input an instruction to execute the word processor program. Then, the word processor program stored in the storage 105 is executed by the controller 101. Accordingly, functions of a word processor are performed, and a document creation window (refer to FIG. 5) is displayed on the display 108. The user can then create a document by operating the keyboard and/or mouse of the operation unit 107 to input text and graphic images.

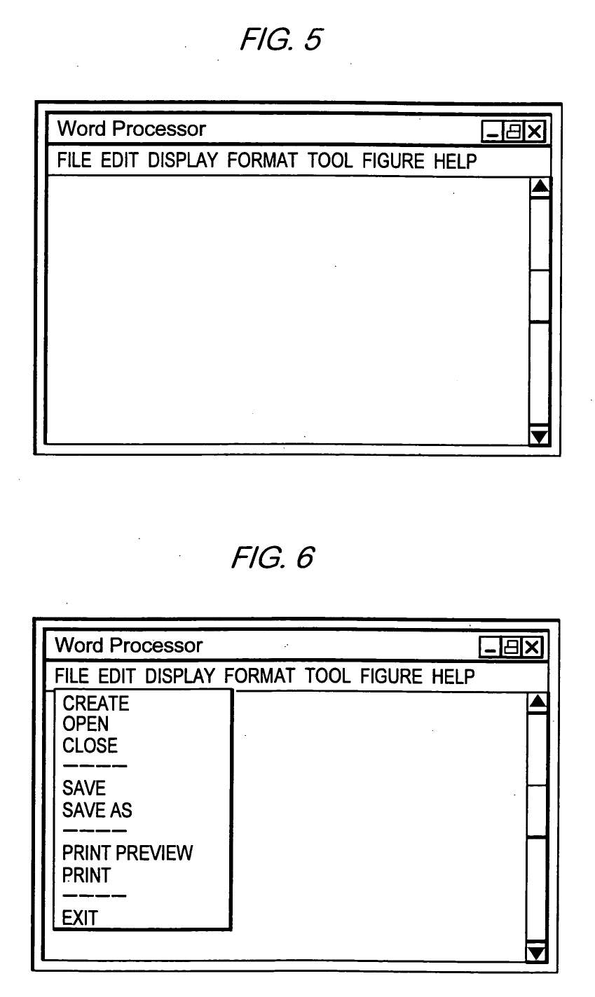

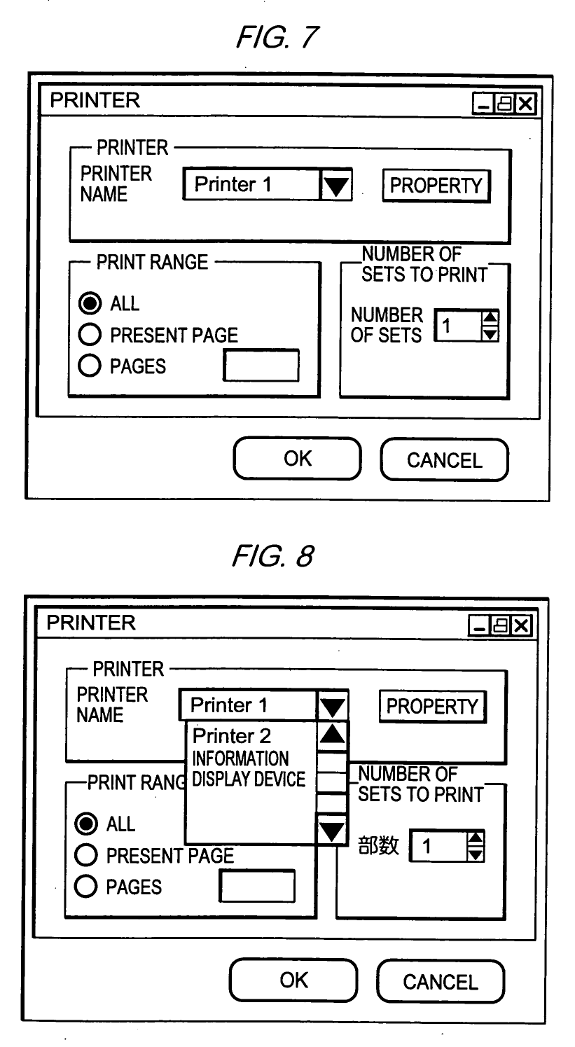

After completion of creation of a document, data expressing an image of the created document is stored into the memory card 3. Specifically, the user firstly inserts a memory card 3 into, for example, the drive 109C. The user secondly clicks on a menu option “file” appearing on a toolbar in the window. Then, a pull down menu opens as exemplarily shown in FIG. 6. The user further clicks on an item “print” from the pull down menu in order to store the data expressing an image of the created document into the memory card 3. In response, a menu screen for setting up printing is displayed as shown in FIG. 7.

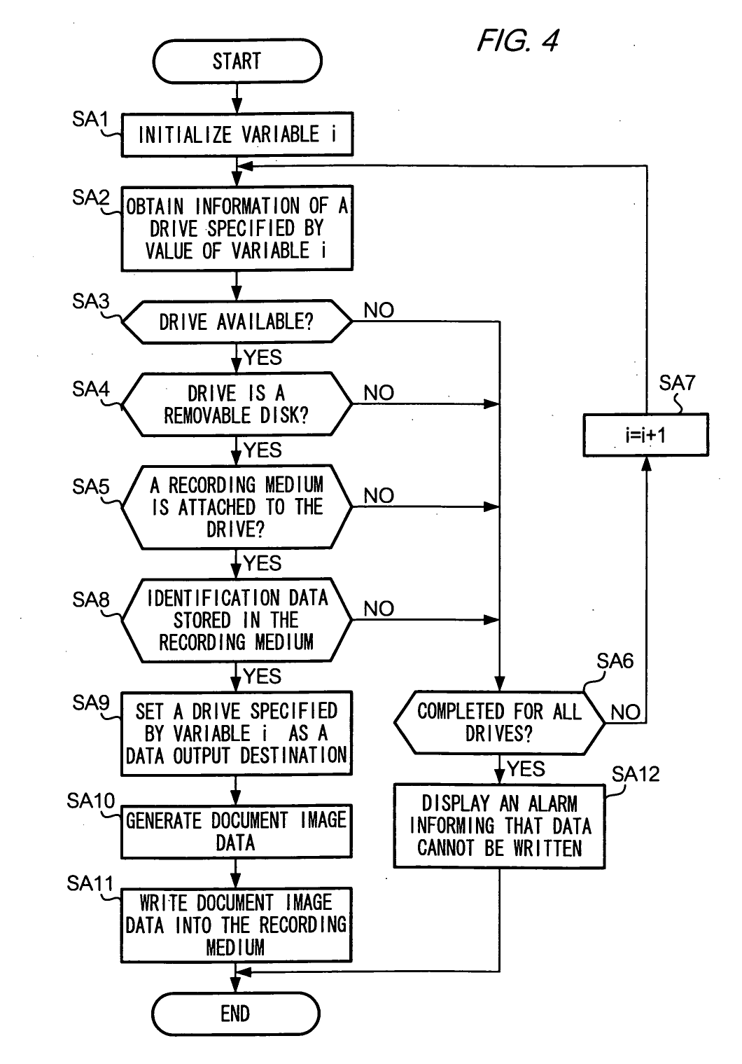

If the user then clicks on a list box named “printer name” in FIG. 7, a list of devices capable of outputting document data is displayed as shown in FIG. 8. The user can further operate the mouse to click on a name “information display device” cited in the list. Thereafter, the user can click on a button “OK” as shown in FIG. 8. In other words, the user can thereafter conduct an operation equivalent to issuance of a write instruction to cause data to be written into the recording medium. If the user does so, the operation unit 107 outputs a signal assigned to clicking of the mouse to the controller 101. The controller 101 receives this signal based on the screen (FIG. 8) displayed at this time, as a write instruction which commands data writing into the recording medium. Upon reception of the write instruction, the controller 101 executes the driver program stored in the storage 105 to carry out a processing shown in FIG. 4.

Specifically, the controller 101 firstly initializes the value of a variable i to “1” (step SA1). Next, the controller 101 obtains information concerning a drive which is specified by the value of the variable i (step SA2). In the information processing device 1 according to the present embodiment, numerical values are respectively allocated to drives after the OS program is started. For example, the allocated numerical values are 1 for drive A, 2 for drive B, 3 for drive C, . . . , and 26 for drive Z. In this manner, each of the drives is assigned a numerical value which specifies the drive. Since the variable i has been initialized to “1”, the controller 101 obtains information concerning the drive A (i.e., information concerning the drive 109A) specific to the numerical value “1” of the variable i. In this case, the OS functions to obtain information indicating whether or not the drive designated at the variable i is available, whether or not the designated drive is a removable drive (from which a recording medium can be detached), whether or not a recording medium is inserted in the designated drive in a case where the designated drive is a removable drive, etc.

After the controller 101 obtains information concerning the drive A, the controller 101 determines whether the drive A is available on the basis of the obtained information (step SA3). Since the drive A (i.e., the drive 109A) is connected to the controller 101, the drive A is available at present. Accordingly, in this case, the controller determines “YES” in the step SA3. Subsequently, the controller 101 determines whether the drive A is a removable drive, also on the basis of the obtained information (step SA4). Since a flexible disk as a recording medium is detachable from the drive A (i.e., the drive 109A), the controller determines “YES” in the step SA4. Subsequently, the controller 101 determines whether a recording medium is inserted in the drive A, also from the obtained information (step SA5). Through the processing as described above, the controller 101 detects a drive to which a detachable recording medium is attached among the plural drives. If no flexible disk is inserted in the drive A, the controller determines “NO” in the step SA5.

If the controller determines “NO” in the step SA5, the controller 101 determines whether the processing for obtaining information concerning a drive has been carried out for all drives (step SA6). In this case, information has not yet been obtained from drives after the drive B. Therefore, the controller determines “NO” in the step SA6, and “1” is added to the value of the variable i (step SA7). The processing flow returns to the step SA2.

The controller 101 obtains information concerning the drive B specified by the value “2” of the variable i. Since no drive B exists in the present embodiment, the controller 101 obtains information indicates that the drive B is not available. Accordingly, in this case, the controller 101 determines “NO” in the step SA3. Further, the controller 101 determines “NO” in the step SA6, and adds “1” to the value of the variable i (step SA7). The controller 101 then returns the processing flow to the step SA2.

Next, the controller 101 obtains information concerning the drive C specified by the value “3” of the variable i. In the present embodiment, the drive C is a hard disk device, and therefore, the obtained information indicates that the drive C is not a removable drive. The controller 101 then determines “NO” in the step SA4, and adds “1” to the value of the variable i after undergoing the step SA6 (step SA7). The controller 101 then returns the processing flow to the step SA2.

Next, the controller 101 obtains information concerning the drive D specified by the value “4” of the variable i, and determines whether the drive D is available on the basis of the obtained information. The drive D (i.e., the drive 109B) is connected to the controller 101 and is therefore available at present. Accordingly, the controller 101 determines “YES” in the step SA3. Next, the controller 101 determines whether the drive D is a removable drive. Since the drive D (drive 109B) is a drive to/from which an optical disk as a recording medium can be attached/detached, the controller 101 determines “YES” in the step SA4. Next, the controller 101 determines whether a recording medium is inserted in the drive D, on the basis of the obtained information. If no optical disk is inserted in the drive D, the controller 101 determines “NO” in the step SA5. If the controller 101 determines “NO” in the step SA5, the controller 101 adds “1” to the value of the variable i after the step SA6 (step SA7). The controller 101 then returns the processing flow to the step SA2.

Next, the controller 101 obtains information concerning the drive E specified by the value “5” of the variable i, and determines whether the drive E is available on the basis of the obtained information. The drive E (i.e., the drive 109C) is connected to the controller 101 and is therefore available at present. Accordingly, the controller 101 determines “YES” in the step SA3. Further, since the drive E is a removable drive, the controller 101 determines “YES” in the step SA4. Next, the controller 101 determines whether a recording medium is inserted in the drive D on the basis of the obtained information. Since a memory card 3 is inserted in the drive E, the controller 101 determines “YES” in the step SA5.

If the controller 101 determines “YES” in the step SA5, the controller 101 accesses the memory card 3 by controlling the drive 109C. The controller 101 then determines whether identification data (as an example of predetermined information) is stored in the memory card 3 (step SA8). Through this processing, the controller 101 controls the drive to which a detachable recording medium is attached. The controller 101 further reads information recorded in the recording medium inserted in the drive, and detects any predetermined information in the read information. presenting this example, the memory card 3 is attached to the drive 109C (step SA8: YES). The memory card 3 has been initialized and stores identification data. The controller 101 sets the drive 109C as an output destination to which data of a document is to be output (step SA9).

After setting the drive as an output destination of data, the user divides a document created by the user into units of pages, and generates a document image for each of the pages (step SA10). After completing generation of data of the document images (hereinafter, document image data), the controller 101 controls the drive 109C to write the document image data (writing of which has been instructed by a write instruction) into the memory card 3 as a recording medium (step SA11).

After completion of writing of the document image data into the memory card 3, the user detaches the memory card 3 from the drive 109C, and then inserts the detached memory card 3 into the drive 205 of the information display device 2. Thereafter, the user operates the operation unit 203, and instructs the information display device 2 to display images of the document image data stored in the memory card 3. The controller 201 then controls the drive 205 so as to read document image data stored in the memory card 3. Further, the controller 201 generates images of the document from the read document image data. Based on the generated images, the controller 201 controls the display 202 so as to display the images of the document. Thus, images of a document created by the information processing device 1 is displayed on the portable information display device 2. Accordingly, the document created by the information processing device 1 is browsed at various places.

In the processing flow shown in FIG. 4, the controller 101 determines “NO” in the step SA5 if no recording medium is inserted in any of the drives. The controller 101 then repeats the processing of the steps SA2 to SA7. Further, if the controller 101 finally determines in the step SA6 that the processing for obtaining information is completed for all of the drives (in the step SA6: YES), the controller 101 displays an alarm to inform a user that document image data cannot be written into any drive (step SA12).

If any recording medium is detected to be inserted in any of the drives in the processing flow shown in FIG. 4 and if no identification data is recorded in the inserted recording medium or media detected, the controller 101 determines “NO” in the step SA8. The processing of steps SA2 to SA7 is then repeated. Further, if the controller 101 determines in the step SA6 that the processing for obtained information has been performed for all of the drives (step SA6: YES), the controller 101 displays an alarm informing a user that the document image data cannot be written into any recording medium (step SA12).

According to the present embodiment, the information processing device 1 automatically specifies a drive in which a memory card 3 which can be used with the information display device 2 is inserted. The information processing device 1 then writes document image data into the memory card 3. Accordingly, when a user inputs an instruction to write data into the memory card 3, the user is not required to carry out a complex operation of designating a drive as a write destination to write the data into. The data can be steadily stored into the memory card 3.

### 3. Modifications

An embodiment of the invention has been described above. However, the invention is not limited to the above embodiment but may be practiced in other various modified forms. For example, the invention may be practiced by modifying the above embodiment in the following manners. Two or more of the modifications described below may be combined together for use.

### 3-1. Modification 1

In the above embodiment, identification data is written as predetermined information into the memory card 3 when the memory card 3 is initialized. The predetermined information is not limited to this identification data. Any information may be used as the predetermined information so long as the memory card 3 can be identified, by the information, to be a memory card which can be used with the information display device 2.

For example, a name of a folder may be used as the predetermined information. In this case, a folder having a particular name is created in the memory card 3 at the time of initialization. The information processing device 1 determines in the step SA8 that a memory card 3 can be used with the information display device 2 if the folder having the particular name exists in the memory card 3. Then, the processing from the step SA9 is performed.

As an alternative example, names of both a folder and a file may be used as the predetermined information. In this case, a folder having a particular name is created in the memory card 3 at the time of initialization. At this time, a file having a particular name is written into the memory card 3. The information processing device 1 determines in the step SA8 that a memory card 3 can be used with the information display device 2 if both the folder having the particular name and the file having the particular name exist in the memory card 3. Then, the processing from the step SA9 is performed. Alternatively, information including at least one of the file having the particular name and a folder having the particular name may be used as the predetermined information.

### 3-2. Modification 2

According to the processing flow shown in FIG. 4, at the time when a drive that has attached to it a recording medium is detected first, data is stored into the detected drive. In the above embodiment, the drives 109A to 109D are assigned successive numbers. Data recording is carried out in an order from a recording medium inserted in the drive assigned a smaller number (more specifically the smallest number) among the plural drives. However, the drive as a target to write data into first is not limited to the drive assigned the smallest number, which is the drive detected first. After it is determined whether a recording medium is inserted (or attached) for all of the drives, one recording medium may be selected from any inserted recording medium or media. For example, in the above embodiment, the information processing device 1 may detect whether initialized memory cards 3 are inserted in both of the drives 109C and 109D. Further, if memory cards 3 are inserted in both of the drives 109C and 109D, icons of drives in which the memory cards 3 are inserted are displayed, to allow the user to select which drive attached with a memory card 3 is to be used to write document image data into.

### 3-3. Modification 3

In a case where plural recording media are detected, information used for selecting a drive as a target of data writing is not limited to the number designating the drive. For example, date/time when a detachable recording medium was attached to a drive may be stored and used as the information. In this case, the controller 101 controls drives so that data is written into a recording medium which was attached at a recent date/time (more specifically the most recent date/time) among the plural detected recording media. More specifically, the information processing device 1 stores date/time on each occasion that a memory card 3 is inserted in a drive. If memory cards 3 are inserted in plural drives, document image data is written into a memory card 3 which was inserted most recently.

Insertion date/time when a memory card 3 is inserted into a drive may be written into the memory card 3. When the controller 101 writes document image data into a memory card 3 in a case where memory cards 3 are inserted in plural drives, the controller 101 reads the written insertion date/time from each of the memory cards 3 and compares the insertion date/time of each of the memory cards 3. The controller 101 writes document image data into a memory card 3 which was inserted most recently.

Alternatively, each drive may store a name of a drive to which a memory card 3 was attached most recently in place of storing insertion date/time of each memory card 3. When the controller 101 writes document image data into a memory card 3 in a case where memory cards 3 are inserted in plural drives, the controller 101 controls a drive specified by the name stored in each drive so as to write document image data into the memory card 3 attached to the drive.

### 3-4. Modification 4

In the embodiment as described above, initialization of each memory card 3 is carried out by the information display device 2. However, the information processing device 1 (more specifically the controller 101 as an initialization unit) may initialize the memory card 3, in place of the information display device 2. In this case, a memory card 3 is inserted in the drive 109C or the drive 109D in the information processing device 1. The information processing device 1 erases data and folders stored in the memory card 3. Thereafter, the information processing device 1 writes identification data into the memory card 3 to initialize the memory card 3.

The above description has been made of an example in which, when a memory card 3 is initialized, identification data is written after erasing of all the data and folders stored in the memory card 3. However, during performing of initialization, identification data may be written after erasing of only data that is used by the information display device 2, in place of erasing of all the stored data and folders.

### 3-5. Modification 5

The above embodiment has been described with reference to a case of using a flexible disk, a CD, a DVD, and a memory card as examples of detachable recording media. Detachable recording media are not limited to these examples. Any type of media such as a magnetic disk, an optical disk, a magneto-optical disk, a semiconductor memory, and a ferroelectric memory may be used as detachable recording media.

For example, a USB (Universal Serial Bus) terminal may be provided in each of the communication units 106 and 204. The information processing device 1 and the information display device 2 may be connected to each other by a USB cable. In this case, the information processing device 1 may be configured so as to recognize USB terminals as drives. Accordingly, the non-volatile memory 201D in the information display device 2 connected by the USB cable is recognized as a recording medium. If only identification data is stored in the non-volatile memory 201D in this configuration, document image data may be automatically written into the nonvolatile memory 201D without a drive selection being made by a user, when the information processing device 1 and the information display device 2 are connected to each other.

### 3-6. Modification 6

Specific operation of the information processing device 1 is not limited to the processing flow as shown in FIG. 4. For example, the information processing device 1 may be configured as follows. If the controller determines “NO” in the step SA8, a menu screen is displayed for prompting a user to input an instruction to initialize a memory card 3. If the user inputs an instruction to initialize the memory card 3, the initialization processing as described above is carried out. Thereafter, the document image data is written into the memory card 3.

Alternatively, in the above embodiment, a device identifier for uniquely identifying the information display device 2 may be written into a memory card 3 at the time of initializing the memory card 3 by the information display device 2.

Further, when document image data is being written into the memory card 3 by the information processing device 1, a menu screen for inputting a device identifier may be displayed before the step SA1 in FIG. 4, so as to allow a user to input a device identifier.

A device identifier stored in the memory card 3 is further read out before the step SA9. If the read device identifier corresponds to the input device identifier, the processing from the step SA9 may be carried out.

A still alternative example supposes a case that plural users use the information processing device 1 and the information display device 2. In this case, a user identifier that uniquely identifies a user may be written into a memory card 3.

Further, when document image data is being written into the memory card 3 by the information processing device 1, a menu screen for inputting a user identifier may be displayed before the step SA1 in FIG. 4, so as to allow a user to input a user identifier.

A user identifier stored in the memory card 3 is further read out before the step SA9. If the read user identifier corresponds to the input user identifier, the processing from the step SA9 may be carried out.

A still alternative example may be configured as follows. That is, an item “save into an information display device” is added to the pull down menu shown in FIG. 6. When a user conducts an operation to select this item, the information processing device 1 carries out processing according to the flow shown in FIG. 4.

A still alternative example may be configured as follows. When a user conducts an operation to select an item “save as”, a user then inputs a file name extension for a file, and instructs the information processing device 1 to store the file. At this time, if the file name extension is a particular extension, the information processing device 1 executes the processing according to the flow shown in FIG. 4, and writes document image data into the memory card 3.

### 3-7. Other Modifications

Hardware configurations of the information display device 2 and the information processing device 1 are not limited to those shown in FIGS. 2 and 3. Any hardware configurations other than those shown in FIGS. 2 and 3 may be adopted so long as required functional configurations can be realized. In the embodiment described above, the controller 101 functions as a reception unit, a first detection unit, a second detection unit, a control unit, and also an initialization unit. Functions of the foregoing units may be respectively (or partially) performed by individual pairs of processors and memories.

In the above embodiment, the program executed by the controller 101 may be supplied as a program stored in a computer-readable recording medium such as a magnetic recording medium (e.g., a magnetic tape or a magnetic disk such as a HDD or a FD), an optical recording medium (e.g., an optical disk such as a CD or a DVD), a magneto-optical recording medium, or a semiconductor memory (e.g., a flash ROM). Otherwise, the program can downloaded via a network such as the internet.

What is claimed is:

1. An information processing device comprising:
a reception unit that receives a write instruction to instruct data writing into a recording medium;
a plurality of drive units that perform data reading/writing from/into a recording media;
a first detection unit that detects a drive unit to which a detachable recording medium is attached, from among the plurality of drive units;
a second detection unit that controls the drive unit detected by the first detection unit so as to read information recorded on the detachable recording medium attached to the detected drive unit, and so as to detect a recording medium, the read information from which includes predetermined information; and
a control unit that controls the drive unit to which the recording medium detected by the second detection unit is attached, so as to write data which is instructed to be written by the write instruction received by the reception unit, into the recording medium attached to the drive unit.

2. The information processing device according to claim 1, wherein the predetermined information includes at least one of a file having a predetermined name and a folder having a predetermined name.

3. The information processing device according to claim 1, wherein
the plurality of drive units are assigned successive numbers, and
if the second detection unit detects a plurality of recording media which include the predetermined information, the control unit performs data writing into a recording medium which is attached to a drive unit assigned the smallest one of the successive numbers from among the detected plurality of recording media.

4. The information processing device according to claim 1, further comprising
a storage unit that stores date/time at which each of the one or more detachable recording media are attached to the one or more drive units, wherein
if the second detection unit detects a plurality of recording media which record the predetermined information, the control unit performs data writing into a recording medium which is attached to a drive unit which was attached at the most recent date/time, from among the detected plurality of recording media.

5. The information processing device according to claim 1, further comprising
an initialization unit that controls the drive unit which has attached to it the detachable recording medium, so as to write the predetermined information into the recording medium.

6. A computer readable storage medium storing a program causing a computer device to execute a process, the process comprising:
receiving a write instruction to instruct data writing into a recording medium;
detecting a drive unit to which a detachable recording medium is attached, from among a plurality of drive units;
controlling the detected drive unit so as to read information recorded on the detachable recording medium attached to the detected drive unit, and so as to detect a recording medium, the read information from which includes predetermined information; and
controlling the drive unit to which the detachable recording medium detected to record the information including the predetermined information is attached, so as to write data which is instructed by the write instruction, into the recording medium attached to the drive unit.
